(19) United States
(12) Patent Application Publication
(10) Pub. No.: US 2010/0250590 A1
(43) Pub. Date: Sep. 30, 2010

(54) System and method for managing energy

(76) Inventor: Brian R. Galvin, Seabeck, WA (US)

Correspondence Address: Brian R. Galvin, P.O. BOX 2360, SILVERDALE, WA, 98383-2360, US

(21) Appl. No.: 12/383,993

(22) Filed: Mar. 30, 2009

(51) Int. Cl. G06F 17/30; G06F 15/16; G06F 1/32

(52) U.S. Cl. 707/770; 709/217; 700/295; 707/E17.044

(57) ABSTRACT

A system for managing energy, comprising a digital exchange with a communications interface adapted to allow connections from remote users over a data network, wherein the digital exchange receives preferences from a plurality of exchange participants and these preferences are used at least in part to create response profiles relevant to the participants, at least some of the response profiles are aggregated into response packages with defined statistical properties, and at least some of the response packages are made available for use by participants in the digital exchange, is disclosed.

### CROSS-REFERENCE TO RELATED APPLICATIONS

None.

### BACKGROUND OF THE INVENTION

1. Field of the Invention

The present invention is in the field of electric power utilities, and in particular in the subfield of smart grid systems. Yet more particularly, the present invention pertains to demand management systems and systems for managing distributed energy resources.

2. Discussion of the State of the Art

While a robust electric power grid is widely recognized as a vital infrastructure component of a developed economy, technological progress in the field of electricity grid systems has not kept up with the pace of other important technological fields such as telecommunications. Most of the electric grid infrastructure has been in place for decades, and the basic architecture conceived by Thomas Edison and enhanced by the likes of George Westinghouse and Samuel Insull still prevails. Additionally, the current regulatory scheme in the United States discourages large-scale investment in transmission and distribution infrastructure, with the unfortunate result that the grid is often running near capacity.

A number of techniques have been devised to assist in maintaining grid stability during times of high stress, which normally means peak usage hours but also includes periods during normal usage when part of the grid goes offline, thus reducing the effective capacity of the grid or a region of it. It is commonplace for “peaking generators”, often operated by independent power producers, to be placed online at peak periods to give the grid greater capacity; since periods of high demand tend to lead to high wholesale power prices, the business model of peaking generator operators is premised on operating their generators only when the price that can be obtained is high. Large utilities, desiring to avoid the use of high-priced peaking generators when possible, also routinely participate in demand response programs. In these programs, arrangements are made by independent third parties with large commercial, industrial, or institutional users of power to give control to the third parties over certain electric loads belonging to large users. These third parties make complementary arrangements with electric utilities to provide “negative load” during peak periods, on demand, by shedding some portion of the loads under their control when requested by the utility. Typically the cost to the utility of paying these aggregators of “negawatts” (negative megawatts, or negative load available on demand) is much less than the corresponding costs the utilities pay to peak generators for actual megawatts. That is, the utilities pay for “dispatchable load reduction” instead of for “dispatchable peak generation”, and they do so at a lower rate. This arrangement is attractive to the utilities not only because of the immediate price arbitrage opportunity it presents, but also because, by implementing demand reduction, the utilities are often able to defer expensive capital improvements which might otherwise be necessary to increase the capacity of the grid.

A problem with the current state of the art in demand reduction is that it is only practical, in the art, to incorporate very large users in demand reduction programs. Large commercial and industrial users of electricity tend to use far more power on a per-user basis than small commercial and residential users, so they have both the motive (large savings) and the means (experienced facilities management) to take advantage of the financial rewards offered by participation in demand management programs. Additionally, large users of electricity already are accustomed to paying a price for power that depends on market conditions and varies throughout the day, and they often have already invested in advanced building automation systems to help reduce the cost of electricity by conserving.

Unfortunately, a large portion (roughly 33%) of the electric power used during peak periods goes to small users, who do not normally participate in demand management. These users often are unaware of their energy usage habits, and they rarely pay for electricity at varying rates. Rather, they pay a price per unit of electricity used that is tightly regulated and fixed. Partly this is due to the fact that the large majority of small businesses and homes do not have “smart meters”; the amount of power used by these consumers of electricity is measured only once per month and thus there is no way to charge an interval price (typically pricing is set at intervals of 15 minutes when interval pricing is in effect) that varies based on market conditions. Furthermore, the loads in the homes and businesses of small electricity users are invisible to the utilities; it is generally not possible for utilities to “see”, much less to control, loads in homes and small businesses. Loads here refers to anything that uses electricity, including but not limited to lighting, heating ventilation and air conditioning (HVAC), hot water, “white goods” (large appliances such as washers, driers, refrigerators and the like), hot tubs, computers, and so forth.

One approach in the art to improving the situation with small users is to install smart meters at homes small businesses. While the primary motivation for doing so is to enable interval-based usage measurement and the communication of interval-based prices to the users, it is also possible to provide the consumer with much more information on how she uses energy than was possible without a smart meter. Given this granular usage information, utilities and some third parties also hope to be able to send signals, either via pricing or “code red” messages (which ask consumers to turn off unnecessary loads due to grid constraints), or both. In some cases, third parties seek to provide visibility and control to utilities so that, when consumers allow it, the utilities can turn loads off during peak demand to manage the peak. A related method involves the use of “gateway” devices to access a consumer's (again, referring to residences, businesses, and institutions) home area networks (HAN) to communicate with or turn off local devices.

It is a disadvantage of the techniques known in the art that the consumers and small businesses are not, in general, provided with any substantial financial incentives to participate in demand reduction programs (other than merely by saving because they use less power). The “virtual power provider” generally sells “negawatts” as previously described by aggregating demand response capability of many small users and selling demand response services to the utility. This method similarly discourages consumer participation, because the majority of the financial rewards associated with the demand response are not generally passed along to the consumer. The companies that aggregate demand typically charge utilities for the peak reduction, but the consumer is unable to sell their available “negawatts” directly to a utility. This is problematic because this methodology reduces consumer incentives to participate in demand side management, which is a necessary component of modern grid management. And adoption is hampered by the general lack of willingness on the part of consumers to allow utilities to control significant portions of their electricity usage with the consumer having little “say” in the matter. And, from the utilities' point of view, the large variations in consumer usage patterns means that it is much harder for utilities to gage how much demand reduction is enough, in advance; compared to large, stable users such as large office buildings or industrial facilities, utilities face a complex mix of user patterns that are difficult to predict and virtually impossible to control. As a result, at the present time almost no demand reduction takes place among consumers and small business users of the electric grid.

Another problem in the art today is the incorporation of distributed generation and storage systems, which are proliferating, into grid demand management systems. In many cases, consumers are unable to do more than to offset their own electric bills with generation units (such as microturbines powered by wind, or solar panels on a roof, or plug-in electric hybrid vehicles that could add energy to the grid when needed), because utilities have neither the means nor the motivation to pay them for the extra electricity they generate. Many states require utilities to buy excess power generated; but, without an ability to sell that generated power at a price that represents a more holistic view of its value that includes “embedded benefits” (i.e. at a rate that may consider, but is not limited to, the effect on enhancing local power quality, proximity to loads, type of power generated and the associated reduction in carbon and other negative externalities—like sulfur dioxide and nitrogen dioxide—and the reduced capital costs resulting from the reduction of required capital investments in infrastructure), most distributed power generation remains economically unfeasible, to the detriment of all parties. With the growing number of markets associated with trading negative externalities associated with electrical power generation (most prominently including carbon, but also nitrogen dioxide and sulfur dioxide), it is necessary to fully account for the value of such energy sources and storage options, and to ensure that double counting of environmental benefits that are related to the generation and distribution of the electricity itself is not conducted. Sulfur dioxide and nitrogen dioxide became regulated in the U.S. under the 1990 Clean Air Act Amendments, which established the EPA's Acid Rain Program to implement a cap-and-trade method to reduce harmful emissions from the electric power industry. Additionally, while storage units may allow users to avoid peak charges and to even the flow of locally generated power (for instance, by storing wind power during high wind conditions and returning it when the wind conditions are low), it is generally not possible for users to sell stored power to the grid operator at its true value for the same reasons.

An additional challenge associated with integrating distribute energy resources with the grid is the lack of a cost-effective means of aggregating distributed power generation into a form that can be traded in a manner similar to the large blocks of power that are bought and sold by more traditional commercial power plants like coal and nuclear. Complex industry rules discourage participation and even consolidators have been hesitant to enter the market given the high set up costs associated with communications, staffing, and industry monitoring. A mechanism is needed to enable equal participation of distributed energy generators (e.g. solar panels on the roof of a home) and traditional power generators in order to encourage the development of these resources.

It is an object of the present invention to provide an effective means of enabling consumers and small businesses to fully participate in, and benefit from, demand reduction programs used by the utilities that serve them. It is a further object of the present invention to provide a means for enabling owners of distributed generation and storage systems to make their power available for sale and distribution across the grid. It is a further object of the present invention to make the embedded benefits associated with the reduction of demand and/or the generation of power—to include, but not limited to, collaborative Greenhouse Gas Programs, carbon credits, sulfur dioxide emissions (SO₂), and nitrogen dioxide emissions (NOx )—from a distributed resource available for sale and trading.

### SUMMARY OF THE INVENTION

In a preferred embodiment of the invention, a system for managing energy, comprising a digital exchange with a communications interface adapted to allow connections from remote users over a data network, is disclosed. According to the embodiment, the digital exchange receives preferences from a plurality of exchange participants, and these preferences are used at least in part to create response profiles relevant to the participants, and at least some of the response profiles are aggregated into response packages with defined statistical properties. Also according to the embodiment, at least some of the response packages are made available for use by participants in the digital exchange.

In another preferred embodiment of the invention, a method for managing energy is disclosed, comprising the steps of receiving preferences from participants in a digital exchange, using those preferences at least in part to create response profiles relevant to the participants, aggregating at least some of the response profiles into response packages with defined statistical properties, and making at least some of the response packages available for use by participants in a digital exchange.

### BRIEF DESCRIPTION OF THE DRAWING FIGURES

FIG. 1 is a block diagram of components of the invention in one embodiment, illustrating a network architecture pertaining to the embodiment.

FIG. 2 is a block diagram of a digital exchange according to an embodiment of the invention.

### DETAILED DESCRIPTION

The inventors provide, in a preferred embodiment of the invention, a system for managing energy particularly adapted for managing electric power demand and distributed generation capacity among a large number of small users, such as consumers and small businesses. The method is based on collecting detailed data about usage patterns from large numbers of such users, including how these usage patterns vary during various time periods, including peak demand periods and periods when sources of renewable energy (such as wind or solar) are unavailable or are available in abundance. Additionally, detailed data on how each user reacts, either automatically or otherwise, to management signals sent during peak demand or other periods, is collected. For example, some users may significantly reduce demand when requested, and may do so promptly. Other users, conversely, may not react at all, or may react sporadically. The same variations in response may occur among operators of distributed generation or storage facilities. There are many reasons why reactions will vary, and even why reactions may significantly deviate from demand reductions that were explicitly volunteered by a user. For example, when a peak period arrives, a user who volunteered to participate in demand reduction might be on vacation, or out of their home for any reason, and so many of the loads that would be targeted may already be secured (turned off). Similarly, some user-owned distributed generation facilities may be able to react to management signals by changing the generation profile, while others (for instance, solar systems) may not be able to change in response to demand management signals (because they are dependent on the sun or another uncontrolled factor).

According to the invention, this usage data is analyzed to create response profiles for each affected user. A response profile reflects the amount of load likely to be actually reduced (or generated) by a user, when requested. The profile may be quite complex, reflecting the varying predicted behaviors for a user on different days, at different times, during different seasons, and so forth. Response profiles can also be generated, according to the invention, on classes of users, large or small, who behave in similar ways; it is not necessary for each user to have an individual response profile. Furthermore, response profiles can be quite dynamic; for example, a response profile may express a conditional behavior such as “if there has been usage of at least X kwh in the two hours prior to the period of interest, then the user is likely at home and the expected response is Y; otherwise the expected response is Z”. In the example given, Z would likely (but not necessarily) be less than Y, and would reflect the fact that both fewer loads are likely to be active (because the user is away, as inferred by lack of use in the earlier period) and that no user reaction to any demand reduction request is possible because the user is likely not at home. In other embodiments of the invention, users may have home automation systems implemented and could receive notification via email, SMS text message or other means while away from home, and thus be enabled to take actions to reduce load when needed; this capability would be reflected in the response profile for such users or classes of users.

In an embodiment of the invention, consumers and small businesses participate voluntarily in supply (generation and storage) or demand (consumption) management programs by establishing preferences. Preferences can take many forms. In some cases, users may state that certain loads are “off limits” or “critical”, and can never be turned off remotely for any load conditions. Other loads may be given one or more attributes that can used to determine if the load is available in any given situation for remote deactivation. Attributes could include time of day, length of time since the load was turned on, length of time since the load was last remotely deactivated, level of criticality of the demand reduction effort, price to be paid for shedding the load (“don't take this load offline remotely unless I will be paid $1 for the sacrifice”), or even the communication required to confirm (for example, “this load can only be turned off if a message is sent to its automatic controller and the automatic controller states that it is safe to turn off the device”). Another user might express the preference that stored solar energy will be placed on the grid when the price is at a certain level, or when the level of criticality of the peak is sufficiently great. It will be appreciated that any number of consumer or small business preferences are possible for controlling when and whether one or more loads are made available for remote deactivation. Moreover, the same considerations that apply for deactivation can also be applied for activation in the case where generating capacity or storage capacity is available. Consumers and small businesses may have, in aggregate, substantial amounts of power in storage or ready to be generated on demand, if the management system was in place to request it and to manage it. Again, each user's supply-side resources (generation and storage capacity) can be made available according to preferences established by a user. Each response profile also reflects the geographic location of the user or class of users to whom it pertains. This information is important for determining which utility, and which particular grid locations (such as substations, tie lines, or regions) will be affected by the activation of the response profile, and to what extent.

In an embodiment of the invention, a number of response profiles are combined to create a response package. Because the statistical behavior of users whose profiles are combined in the response package is known, and because a large number of profiles are normally combined into a package, it is possible according to the invention to estimate with good accuracy how much load reduction (or generation) each response package represents. For example, a response package made up of the collected response profiles of 10,000 consumers might be expected to yield 1.5 MWh (megawatt-hours) of load reduction during a particular 15-minute peak load period. Each time this response package is “invoked” (that is, each time a signal is sent to all the users represented by the response package), the actual demand change effected is measured, and used to refine the statistical model for each response profile and for the response package as a whole. In this way, according to the invention, the system for energy management continually adjusts to maintain highly accurate models of supply and demand changes in response to invocations of response packages (reductions through load shedding or additions through generation of power or release of power from storage). As with response profiles, each response package has a geographic element. For instance, it may represent elements (loads and generation/storage elements) spread across a particular utility's area of responsibility, or it may represent elements in a particular urban region.

In a preferred embodiment of the invention, response packages are made available for purchase by third parties. The purchasers could be utilities who desire to directly manage demand, or they could be aggregators who resell demand management to utilities at peak period. According to the invention, a given response package can be sold for any time period at any time in the future (or indeed for the current time period). Thus a response package for reducing load in San Francisco by 10 MWh for the 15-minute interval starting at noon on Friday, Mar. 31, 2010 could be sold at any time before 12:15 on that day. Because the package is sold, according to a preferred embodiment of the invention, on an open market, it is likely that the price would vary over time based on market participants' estimates of the likely demand for power at the critical time for this package (that is, at 12:00 on March 31^{st}). In principle, the package can be sold more than once according to the invention, although in the end only one “owner” is able to actually elect to invoke the demand response action represented by the package. It should be noted that actual exercise of the demand response action represented by any given response package is necessary according to the invention; if load conditions are markedly different from what the final purchaser expected, that entity may elect not to incur additional costs (described below) by actually exercising the demand response action.

According to an embodiment of the invention, consumers make their preferences concerning their willingness to participate in energy management actions (that is, load reductions or provision of power from generators or storage systems) on demand. Since consumers are unlikely to be willing to enter into long-term forward contracts for electric power actions that they may find quite unpalatable when the critical day arrives (for instance, if the weather is much warmer than expected, consumers may balk at letting their air conditioners be turned off), it is possible according to the invention for consumers to override their preferences at any time. Indeed this is one of the reasons that relying on consumers for demand response is so problematic, and why utilities seek to have remote control whenever possible (although this is rarely possible, and is even illegal in some jurisdictions because of regulatory requirements). In order to provide a level of control that consumers will want or require, and to provide a reasonable energy management capability to utilities, the combination of a number of consumers' (again, these can also be businesses) response profiles into response packages of sufficient size that they will be large enough to be useful and will have predictable statistical behavior, is carried out. According to a preferred embodiment, when a utility or other entity actually invokes a response package (for instance, by actually requesting the demand to be reduced by 10 MWh during the critical period), all of the end users that make up the response package are sent signals directing them to take the appropriate actions which they previously volunteered to take. While some will fail or refuse to do so, this has generally already been taken into account by building the response profiles and the response package to reflect the statistical patterns that this particular package of users has shown in the past, so according to the invention the actual demand response seen should closely approximate that specified as the “rating” of the response package (in the example above, the rating would be 10 MWh of demand reduction in the target time period).

Actual responses that occur when a response package is invoked is measured according to the invention. This measurement is used to refine statistical models used for response profiles, as described above. Also, according to an embodiment of the invention, an invoking entity (an entity which invoked a supply or demand response action associated with the response package) may optionally only be charged according to a supply or demand response that actually took place. For instance, while 10 MWh was forecasted and requested, if only 9.5 MWh was actually achieved, the price paid by an invoking entity would be reduced. The reduction could be linear, so that in the example given the entity's actual price is reduced by 5%, or it could be set by any formula agreed in advance by the parties in the marketplace (for instance, the price difference could be set at 5% reduction for any shortfall from 0% to 5%, 10% for any shortfall above 5% but less than or equal to 10%, and so forth). It should be appreciated that any price adjustment schema can be used according to the invention, and that similar adjustments (or no adjustment) could be made if the response action exceeded what was requested (typically, one would expect that any overage would not be charged to an invoking entity, but this is not required according to the invention).

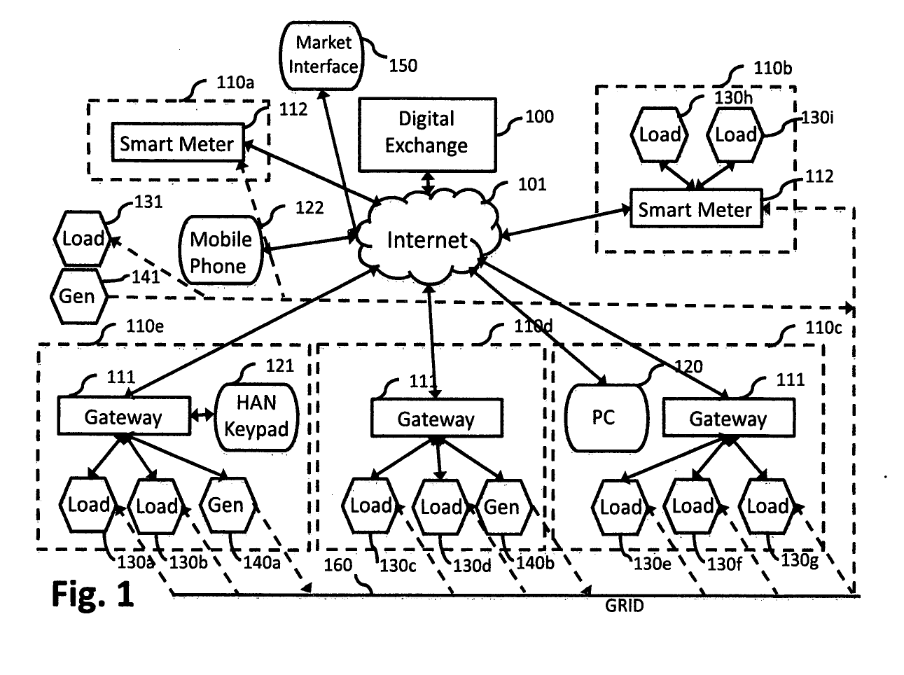

FIG. 1 illustrates a network architecture according to a preferred embodiment of the invention. A digital exchange 100 acts as a control point according to an embodiment. Users such as small businesses and consumers participate by interacting with the digital exchange 100. Interaction is normally conducted by connecting to the digital exchange 100 via the Internet 101, although this is not necessary according to the invention. Interaction between users and the digital exchange 100 can be conducted by any suitable communications medium, such as wired or wireless telephony. In various embodiments of the invention, users interact with the digital exchange 100 through the use of mobile phones 122, personal computers (PCs) 120, or a home area network (HAN) keypad 121 such as might be used as part of a home automation system. While according to a preferred embodiment of the invention interaction data such as preferences or requested actions are passed over the Internet 101 to and from users via one or more of these various devices, it should be appreciated that web-based services can today be delivered over a large and growing number of device types and communications networks without departing from the scope of the invention. For instance, a user could establish a multimodal voice-and-data session from a “smart mobile phone” over both the Internet 101 and the wireless telephony network, and use both voice and data channels to interact with a digital exchange 100 according to the invention. Furthermore, some market participants (that is, participants in an energy market established according to the invention through a digital exchange 100), such utilities or energy aggregators, may interact with a digital exchange 100 either directly or over the Internet 101 from a market interface 150. In some embodiments, market interface 150 is a dedicated server operating software adapted to communicate with the digital exchange 100 via hypertext transfer protocol (HTTP), extensible markup language (XML) or a specialized protocol using XML, remote procedure calls (RPC), the SOAP web services protocol, or any of a number of well-established data integration methods well-known in the art. Consumers and small business owners interact with a digital exchange 100 in order to identify and authenticate themselves, to identify energy resources (for example, loads such as appliances, computers, hot tubs, etc., supply-side resources such as storage devices or generators, although the invention should be understood to encompass any energy resources capable of being controlled by homeowners or small business operators), and to establish preferences concerning how and when any resources so identified are to be available actions requested by the digital exchange 100. Examples of preferences that might be expressed according to the invention are levels of criticality of loads, aminimum prices at which resources are to be considered available for use, special times of day or particular days when specific resources (or even all resources) are to be considered available for use (or to be not available for use). In general, the invention should not be considered limited to any particular set or sets of preferences, as any preferences that may be useful to a particular user or groups of users and that is capable of being honored by a digital exchange 100 are permissible according to the invention. Users may also establish preferences concerning what amount of data concerning a user or his energy resources a digital exchange 100 is allowed to retrieve, and under what conditions (length of time, degree of anonymity, and the like) such data is to be allowed to be retained by a digital exchange 100.

According to an embodiment of the invention, a home or small business 110c comprises a plurality of electric loads 130 that are connected to, and draw electric power from, an electric grid 160. At least some of loads 130 are further adapted to communicate with a gateway 111. Electric loads 130 can be any kind of electric load capable of being operated in a home or small business, such as major appliances (washers, driers, and the like), electronics (computers, stereos, televisions, game systems, and the like), lighting, or even simply electric plugs (which can have any actual load “plugged into” it, or no load at all). In some embodiments, loads 130 have current sensing and control circuitry capable of communicating with a gateway 111 built in (for example, “smart thermostats” and “smart appliances”, which are well-known in the art); in other cases, loads 130 may be connected through wall sockets, surge suppressors, or similar switching devices, which are adapted to be able to communicate with a gateway 111. In some embodiments, information about the current or power flowing through a load 130 is passed to a gateway 111. In other embodiments, only information about the status of the load, such as whether it is on or off, is provided to a gateway 111. Communications between gateway 111 and loads 130 can be wireless, using a standard such as the ZigBee wireless mesh networking standard or the 802.15.4 wireless data communications protocol, or can be conducted using a wired connection using either power lines in the home or small business (broadband over power lines) or standard network cabling. The actual data communications protocol used between a gateway 111 and a load 130 may be any of the several data communications protocols well-known in the art, such as TCP/IP or UDP. According to an embodiment of the invention, a gateway 111 is connected via the Internet 101 to a digital exchange 100 using an Internet Protocol (IP) connection; as with communications between user interface devices and a digital exchange 100, communications between a gateway 111 and a digital exchange 100 can be established using any of the means well-known in the art, including but not limited to HTTP, XML, SOAP, and RPC.

In an embodiment of the invention, a home or small business 110c communicates with a digital exchange 100 via the Internet 101 or a similar data network. According to the embodiment, data is pushed from a gateway 111 to a digital exchange 100 in order to provide information concerning condition of loads 130. For example, gateway 111, at a specified time interval, may report to digital exchange 100 that load 130e is running and using 1.5 amps of current (or 180 watts of power), and that load 130f is off, and that load 130g is running in power-conservation mode (for example, if load 130g is a computer and is adapted to provide its energy-management mode to a gateway 111). In other embodiments, gateway 111 may pass periodic updates to digital exchange 100 and supplement the regular updates with event-based updates (for example, when a load 130f turns on). In yet other embodiments, digital exchange 100 pulls data from gateway 111 either on a periodic basis or on an as-needed basis. It will be understood by those having ordinary skill in the art that many combinations of push and pull, periodic and event-driven update strategies may be used by one or more gateways, or by a single gateway at different times, or indeed even by a single gateway at one time, with different techniques being used for different loads. Users in a home or small business 110c can communicate with the digital exchange 100 as described above using a PC 120, a telephone such as a mobile phone 122, a dedicated home area network keypad 121, or directly on gateway 111, which can alternatively be equipped with a screen such as an LED screen or a touchpad, and optionally with buttons, sliders and the like for establishing preferences that are then transmitted to the digital exchange 100.

According to another embodiment of the invention, a home or small business 110c comprises a plurality of electric loads 130 that are connected to, and draw electric power from, an electricity grid 160, and further comprises a plurality of generation and storage devices 140 that are connected to, and adapted to provide power to, an electricity grid 160. At least some of loads 130 and generators 140 (taken here to include storage devices that can provide electricity on demand to the grid 160) are further adapted to communicate with a gateway 111. Electric loads 130 can be any kind of electric load capable of being operated in a home or small business, such as major appliances (washers, driers, and the like), electronics (computers, stereos, televisions, game systems, and the like), lighting, or even simply electric plugs (which can have any actual load “plugged into” it, or no load at all). In some embodiments, loads 130 have current sensing and control circuitry capable of communicating with a gateway 111 built in (for example, “smart thermostats” and “smart appliances”, which are well-known in the art); in other cases, loads 130 may be connected through wall sockets, surge suppressors, or similar switching devices, which are adapted to be able to communicate with a gateway 111. In some embodiments, information about the current or power flowing through a load 130 is passed to a gateway 111. In other embodiments, only information about the status of the load, such as whether it is on or off, is provided to a gateway 111. Electricity generators 140 can be any kind of device capable of providing power to an electricity grid 160, including but not limited to wind turbines or other wind-driven generators, photovoltaic cells or arrays or other devices capable of converting sunlight into electricity, electricity storage devices such as batteries and pumped hydro storage facilities, and the like. Communications between gateway 111 and loads 130 and generators 140 can be wireless, using a standard such as the ZigBee wireless mesh networking standard or the 802.15.4 wireless data communications protocol, or can be conducted using a wired connection using either power lines in the home or small business (broadband over power lines) or standard network cabling. The actual data communications protocol used between a gateway 111 and a load 130 or a generator 140 may be any of the several data communications protocols well-known in the art, such as TCP/IP or UDP. According to an embodiment of the invention, a gateway 111 is connected via the Internet 101 to a digital exchange 100 using an Internet Protocol (IP) connection; as with communications between user interface devices and a digital exchange 100, communications between a gateway 111 and a digital exchange 100 can be established using any of the means well-known in the art, including but not limited to HTTP, XML, SOAP, and RPC.

In an embodiment of the invention, a home or small business 110c communicates with a digital exchange 100 via the Internet 101 or a similar data network. According to the embodiment, data is pushed from a gateway 111 to a digital exchange 100 in order to provide information concerning condition of loads 130 and generators 140. For example, gateway 111, at a specified time interval, may report to digital exchange 100 that generator 140b is running and generating 500 watts of power, and that load 130c is off, and that load 130d is running in power-conservation mode (for example, if load 130d is a computer and is adapted to provide its energy-management mode to a gateway 111). In other embodiments, gateway 111 may pass periodic updates to digital exchange 100 and supplement the regular updates with event-based updates (for example, when a load 130c turns on). In yet other embodiments, digital exchange 100 pulls data from gateway 111 either on a periodic basis or on an as-needed basis. It will be understood by those having ordinary skill in the art that many combinations of push and pull, periodic and event-driven update strategies may be used by one or more gateways, or by a single gateway at different times, or indeed even by a single gateway at one time, with different techniques being used for different loads. Users in a home or small business 110d can communicate with the digital exchange 100 as described above using a PC 120, a telephone such as a mobile phone 122, a dedicated home area network keypad 121, or directly on gateway 111, which can alternatively be equipped with a screen such as an LED screen or a touchpad, and optionally with buttons, sliders and the like for establishing preferences that are then transmitted to the digital exchange 100.

According to another embodiment of the invention, a home or small business 110b comprises a plurality of electric loads 130 that are connected to, and draw electric power from, an electric grid 160 via a connecting smart meter 112 that is adapted to meter electricity usage within home 110b. At least some of loads 130 are further adapted to communicate with a smart meter 112. Electric loads 130 can be any kind of electric load capable of being operated in a home or small business, such as major appliances (washers, driers, and the like), electronics (computers, stereos, televisions, game systems, and the like), lighting, or even simply electric plugs (which can have any actual load “plugged into” it, or no load at all). In some embodiments, loads 130 have current sensing and control circuitry capable of communicating with a smart meter 112 built in (for example, “smart thermostats” and “smart appliances”, which are well-known in the art); in other cases, loads 130 may be connected through wall sockets, surge suppressors, or similar switching devices, which are adapted to be able to communicate with a smart meter 112. In some embodiments, information about the current or power flowing through a load 130 is passed to a smart meter 112. In other embodiments, only information about the status of the load, such as whether it is on or off, is provided to a smart meter 112. Communications between smart meter 112 and loads 130 can be wireless, using a standard such as the ZigBee wireless mesh networking standard or the 802.15.4 wireless data communications protocol, or can be conducted using a wired connection using either power lines in the home or small business (broadband over power lines) or standard network cabling. The actual data communications protocol used between a smart meter 112 and a load 130 may be any of the several data communications protocols well-known in the art, such as TCP/IP or UDP. According to an embodiment of the invention, a smart meter 112 is connected via the Internet 101 to a digital exchange 100 using an Internet Protocol (IP) connection; as with communications between user interface devices and a digital exchange 100, communications between a smart meter 112 and a digital exchange 100 can be established using any of the means well-known in the art, including but not limited to HTTP, XML, SOAP, and RPC.

In an embodiment of the invention, a home or small business 110c communicates with a digital exchange 100 via the Internet 101 or a similar data network. According to the embodiment, data is pushed from a smart meter 112 to a digital exchange 100 in order to provide information concerning condition of loads 130. For example, smart meter 112, at a specified time interval, may report to digital exchange 100 that load 130e is running and using 1.5 amps of current (or 180 watts of power), and that load 130f is off, and that load 130g is running in power-conservation mode (for example, if load 130g is a computer and is adapted to provide its energy-management mode to a smart meter 112). In other embodiments, smart meter 112 may pass periodic updates to digital exchange 100 and supplement the regular updates with event-based updates (for example, when a load 130f turns on). In yet other embodiments, digital exchange 100 pulls data from smart meter 112 either on a periodic basis or on an as-needed basis. It will be understood by those having ordinary skill in the art that many combinations of push and pull, periodic and event-driven update strategies may be used by one or more gateways, or by a single gateway at different times, or indeed even by a single gateway at one time, with different techniques being used for different loads. Users in a home or small business 110c can communicate with the digital exchange 100 as described above using a PC 120, a telephone such as a mobile phone 122, a dedicated home area network keypad 121, or directly on smart meter 112, which can alternatively be equipped with a screen such as an LED screen or a touchpad, and optionally with buttons, sliders and the like for establishing preferences that are then transmitted to the digital exchange 100. It will be appreciated that the description above of the communications associated with a home or small business 110d comprising both loads and generators is equally applicable to homes or small businesses in which a smart meter 112 is used in place of a gateway 111, with a smart meter 112 performing similar functions to a gateway 112 in addition to its normal role of metering power usage.

In some cases, homes 110a may only pass aggregate electricity consumption data to a digital exchange 100 from a smart meter 112, either via the Internet 101 or a special-purpose data communications network adapted for communications between smart meters 112 and utility-based data systems. In these cases, even though there is no visibility at the digital exchange level to the individual loads and generators in homes 110a, it is still possible according to the invention for a digital exchange to receive usage data (from smart meter 112) and to send requests for action (for instance, via a text message to a mobile phone 122 or even a phone call to a regular phone located at the home or small business 110a, asking the consumer to shed unnecessary loads due to high electricity demand or to attempt to place any generating units online in response to a need at the electricity grid 160). Since any changes in load measured by smart meter 112 at home or small business 110a would be sensed by digital exchange 100 shortly after the request went out, the response profile of such smart meter-only users can be included in response packages according to the invention. Even further, it is possible to include entirely unmonitored loads 131 and generators 141 (again, taken to include storage systems capable of injecting power onto the grid 160); “unmonitored” as used here means that the usage of loads 131 and generators 141 is not monitored in real time or near real time by digital exchange 100. The use of unmonitored loads 131 and generators 141 can still be beneficial according to the invention. For example, in an embodiment of the invention some users register unmonitored loads 131 and generators 141 with the digital exchange 100 using one of the user interface methods discussed earlier (for example, via a website associated with digital exchange 100). Optionally, the registering user can also provide certified records of past operation of the unmonitored loads 131 or generators 141, which can be used according to the invention as input to be used in building a response profile for the unmonitored loads 131 or generators 141. These unmonitored response profiles can be included in larger response packages, with or without discounting of the capacity of the unmonitored loads 131 or generators 141 to account for the fact that these devices are unmonitored. Then, when a response package including such unmonitored loads 131 or generators 141 is activated, an activation message is sent to users of unmonitored loads 131 and generators 141 advising them of the required action to take. Messages are sent via any communications medium, including but not limited to phone calls, text messages, emails, or alerts on a website that may be monitored manually or automatically by users of unmonitored loads 131 and generators 141. Accounting for whether such users actually take the requested actions is done in two ways. First, the statistical profile of the response profile for such energy resources will include the expected behavior (for example, the action will be taken 55% of the times it is requested); this is used by digital exchange 100 to build a response package that behaves as expected. Second, audits may be contractually required and conducted in which actual usage of unmonitored loads 131 and generators 141 is checked periodically (for example, monthly), by a third party or with sufficient safeguards against fraud as are needed to satisfy business needs of a digital exchange 100. These needs will vary depending on the context. For example, some users of unmonitored loads 131 and generators 141 will want to voluntarily participate and expect no remuneration for their participation; in these cases, it is not important to have a level of confidence sufficient for the disbursement of funds, but only a level of understanding of expected behaviors to enable a refinement of the statistical model of the response profile. In other cases, users of unmonitored loads 131 and generators 141 will expect to be paid for their participation, and therefore will likely agree to contractual terms including right of audit, for example of tamper-proof device usage logs.

In another embodiment of the invention, one or more of loads 130 are monitored by “clip-on” current measuring devices which are clipped around a load-bearing able in order to sense the current flowing through the cable. In an embodiment, the clip-on current sensor is adapted to monitor one or more phases of the main current flowing into a home or a small business, essentially acting (via its wireless connection to a gateway 111) as a clip-on smart meter.

It will be seen from the various embodiments illustrated in FIG. 1 that essentially any arrangement of communications will suffice as long as it allows users of energy resources to establish their preferences, and operators of digital exchange 100 to build statistical models of expected responses to requests to take action, and operators of digital exchange to send notification of requested actions to users of energy resources according to their preferences.

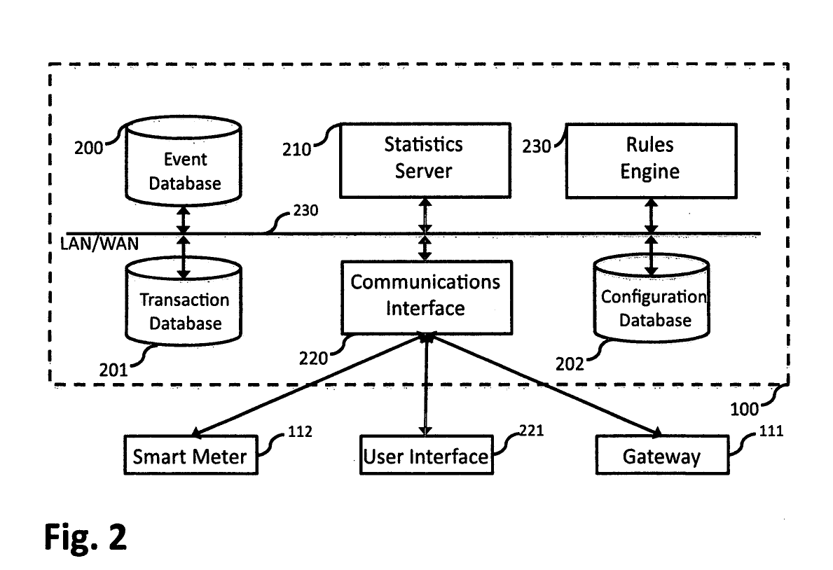

FIG. 2 illustrates a digital exchange 100 according to an embodiment of the invention. A communications interface 220 is adapted to communicate with a plurality of user interfaces 221, gateways 111, and smart meters 112. As discussed above, user interfaces 221 may be of many kinds according to the invention, including but not limited to web browsers on personal computers, laptop computers, smart phones or other browser-equipped devices, telephones, and the like. Communications interface 220 is adapted to provide one or more interface means for connection to end devices such as smart meters 112, user interfaces 221, and gateways 111. Interface means may support various standards such as HTTP, SOAP, RPC, XML, SCADA, VXML, and the like, or may be implemented in a proprietary way; the scope of the invention should not be taken as limited to any particular means of communication between the digital exchange 100 and end users and their energy resources. Digital exchange 100 may be implemented on a single server or other computing device, or its functions may be dispersed among several servers or computing devices as desired. The various modules of the digital exchange shown in FIG. 2 communicate with each other via a network 230, which can be a local area network (LAN), a wide area network (WAN), the Internet 100, or any other network capable of providing for communication between the various elements of a digital exchange 100.

A configuration database 202 stores information pertaining to the configuration of the components of a digital exchange 100, as well as information pertaining to users who have registered with the digital exchange 100. When new users connect with a digital exchange via communications interface 220 from a user interface 221, they are guided through a registration process. Details of this process will vary in accordance with the invention, but will typically include at least the collection of identifying information concerning the user and information to enable the communications interface 220 to connect to a smart meter 112 or gateway 111 associated with the user, as appropriate. According to an embodiment of the invention, when a user provides information enabling a communications interface 220 to find and connect to an associated smart meter 112 or gateway 111, the communications interface 220 queries the smart meter 112 or gateway 111 to obtain a list of devices or energy resources monitored and addressable by the smart meter 112 or gateway 111. For instance, a gateway may return a list of several loads 130 and one or more generators or storage devices 140. Optionally, a user may view the list of associated devices or energy resources and provide, via user interface 221, detailed information about one or more of the devices or energy resources. For example, a user might start with a list of monitored outlets and appliances that was obtained by communications interface 220 from smart meter 112 or gateway 111, and manually provide the information that outlet #7 has a Dell Inspiron computer connected to it, outlet #8 has a 17-inch monitor connected to it, appliance #1 is a Kenmore washer of a specific model, and so forth. The list of “acquired” devices or energy resources, and all associated amplifying information concerning those devices or energy resources, are stored in configuration database 202. According to an embodiment of the invention, configuration database 202 is also populated with a set of data about the standard energy usage profiles of known brands and models of electric devices. For example, information may be stored in configuration database 202 concerning the power consumption of various models of Kenmore washers and driers, as well as additional detailed information such as the various duty cycles and their associated power consumption profiles (the consumption of power by a washer, for instance, will vary dramatically at different stages of its various duty cycles). Information concerning precautions to be observed when considering deactivating particular devices is also optionally stored in configuration database 202; for instance, it may be unsafe for a washer to turn it off during a spin cycle, whereas it might be perfectly safe to turn it off during a fill cycle.

According to a preferred embodiment of the invention, user preferences are stored in configuration database 202. While interacting with digital exchange 100 using user interface 221, users are given options to express preferences for how their energy resources may (or may not) be used by a digital exchange 100 to build response profiles and response packages or to execute energy management actions that involve the user's energy resources. As discussed above, preferences can be quite wide-ranging according to the invention, and may include mandatory preferences (preferences that a digital exchange is not allowed to violate, such as “never turn off my television on outlet #14”), or optional preferences with conditions (for example, “if the price is more than X degrees, and my hot water temperature is at least Y, and it is between 8:00 am and 4:00 pm local time, you can turn off my hot water heater for as long as needed or until the temperature drops to Z degrees”), or highly permissive preferences (“you can do whatever you want to this load, whenever you want”).

According to a preferred embodiment of the invention, events are stored in event database 200. According to the invention, a very wide range of events may be stored in event database 200. For example, each packet of data concerning the state of a device or energy resource can be considered an event and stored in event database 200. To illustrate, consider a washing machine that is monitored and controlled by a gateway 111 in the home of a user of a digital exchange 100. When the washing machine turns on, an event is generated to record that the device activated at a specific time. If the gateway 111 is configured to pass frequent power readings for the device, then a series of events of the form “device N was consuming X kilowatts at time T” is passed by gateway 111 via communications interface 220 and stored in event database 200. Similarly, if a response package is activated, and event is generated; if a particular response action is requested, an event is generated, and if the requested action is taken, another event is generated; all of these exemplary events are stored in event database 200. It is desirable, according to the invention, to capture events at as granular a level as is possible for any given configuration (for example, as in the case of home 110a described above, it may only be possible to have information at the level of detail of a home, whereas in the case of home 110c discussed above, device-level granularity is possible). According to the invention, configuration changes may also constitute events and be stored in event database 200, enabling an audit trail to be maintained (that is, configuration database 202 stores the current configuration but event database 200 will have a complete record of changes to configuration database 202). Extraneous events, which are events not directly recorded by smart meters 112, gateways 111, or other sources within the digital exchange infrastructure, may be entered manually or automatically into the event database 200. For instance, if a third party provides weather forecast information or actual weather information (for example, “it is snowing in Wichita at time 1:00 pm”), this information can be stored in event database 200. This is useful according to the invention because it may be possible to correlate changes in aggregate load across many connected users (connected to the communications interface 220) with weather phenomena in a very detailed way.

According to a preferred embodiment of the invention, transaction database 201 stores information pertaining to partial, pending, completed, and closed transactions. According to the invention, partial transactions may include transactions to which only one party is committed at a given point in time; for instance, an offer to sell the right to invoke a particular response package at a particular time in the future, or a request to obtain a specified level of demand reduction at a specified time in the future, when neither the offer nor the request has been taken up by a second party. Pending transactions according to the invention include situations where two parties are committed to a transaction but the underlying energy actions have not yet been consummated; for instance, if a utility has purchased the rights to invoke a response package at a specified time but either that time has not yet arrived or, if it has arrived, the utility has chosen to not execute the response package yet. Completed transactions are transactions for which the underlying energy resource actions have been taken. Closed transactions are transactions for which all settlement actions, such as verifying actual energy response actions taken, by user, allocating funds among various users who participated, and satisfying all financial aspects of the transaction for all parties involved, have been completed.

It should be appreciated by those practiced in the art that the various databases described herein are for illustrative purposes only. The functions of all of them can be included in a single database system, or the functions could be distributed over a larger number of database systems than outlined herein, without departing from the spirit and the scope of the invention. For example, a configuration database 202 could contain only configuration information pertaining to physical things such as locations of smart meters 112 and gateways 111, and consumer preference information could be stored in a separate preferences database, without departing from the scope of the invention. What is relevant to the invention is the set of information stored and the uses to which it is put, rather than precisely how it is stored; the field of database management is very advanced and those having practice in that art will appreciate that there are many considerations having nothing to do with the instant invention that may dictate one or another particular architectural approach to database storage.

According to an embodiment of the invention, statistics server 210 calculates a plurality of statistics based on data take from or derived from one or more of a configuration database 202, a transaction database 201, and an event database 200. Statistics can be calculated on request from clients of the statistics server 210 such as a rules engine 230 or user interfaces 221 provided via communications interface 220. Statistics can also be calculated according to a prearranged schedule which may be stored in a configuration database 202; alternatively statistics may be calculated periodically by statistics server 210 and pushed to clients or applications which may then choose to use the passed statistics or not. According to an embodiment of the invention, statistics server 210 is used to characterize an expected response profile of a plurality of end users of a digital exchange 100, which response profile may be for a particular period of time or for any period of time; optionally time-specific and time-independent response profiles for a plurality of end users may both be calculated. According to another embodiment of the invention, statistics server 210 is used to characterize expected response from a response package built up from a plurality of end user response profiles, which expected response may be for a particular period of time or for any period of time; optionally time-specific and time-independent response forecasts for a plurality of response packages may both be calculated. Statistics can be stored in a separate database such as an event database 200, or they may be delivered in real time to a requesting client or application such as a rules engine 230.

According to various embodiments of the invention, statistics server 210 calculates statistics based on a wide variety of available input data. For example, statistics server 210 can calculate the expected load reduction to be delivered by a single end user or a collection of end users on receipt of a request for a reduction in load. This may be calculated based on any available data from event database 200, transaction database 201, configuration database 202, or any other data source accessible to statistics server 210 (for instance, weather data passed directly in to statistics server from a third party via communications interface 220). Data elements which may be used to calculate response profiles may include, but are not limited to, past history of responses to similar response requests at the same or different times and on the same or different days. Response profiles can be calculated based on a type of load to be reduced; for example, if a user has volunteered to make several resistive loads such as water heaters and resistive space heaters available for reduction on demand, expected response may be calculated by estimating the probability that said loads are actually active at the time of a request, based on previous history of the activation times for said loads. Alternatively, said resistive loads might always be on, yet an end user might occasionally override response actions locally, and statistics server 210 may estimate likely load reduction by estimating the probability that an end user will override a demand reduction signal based on previous override history. In both of these examples, and indeed in any statistical calculation made by statistics server 202, previous history data can be for the user concerning whom a statistics is being calculated, or it can optionally be historical data from a plurality of users who are judged by statistics server 210 to have similar characteristics. This allows, for instance, a new user to be incorporated readily into the system and methods of the invention by allowing historical data for already-active users with similar characteristics to be used to estimate the expected behaviors of said new user. In an embodiment of the invention, demand management may be achieved by altering duty cycles of appropriate loads rather than merely turning them off; for example, setpoints of an advanced thermostat could be adjusted by one or more degrees in order to reduce the aggregate HVAC load controlled by the thermostat, or a hot water heater could be allowed to stay offline until water temperature drops to some predefined temperature, at which point the heater would turn on. In these cases, the preferences are stored in a configuration database 202, and statistics server 210 calculates expected response by, for example, deriving a response function, expressed as a function of time (where time can be defined in various ways, such as the time since the last duty cycle started, the time since a critical parameter was last reached, or the time from the response request's transmission to the device; this list is not exhaustive and should not be taken as limiting the scope of the invention), which characterizes the typical response for the device. Then, a calculation of the likely response can be made using this function and included in a response profile. Note also that whenever information about a device type, such as a particular type or model of washer, dryer, thermostat, or any other device, is contained in a configuration database, information from either the manufacturer of a device or an aggregated history from many such devices used by various participants in digital exchange 100, can be used in lieu of actual usage information from any particular user if desired. In this way, response profiles can be built up with high accuracy for even very new users (or for users who do not have equipment that enables current or power measurements per device, as upon listing various devices a response profile can be built using typical response profiles for each device the user lists).

In another embodiment of the invention, expected response profiles can be based at least in part on information that is either real time in nature or nearly so. For example, when information about current status of equipment (on or off, and potentially at which point in a duty cycle) can be gathered, it can be used to modify a response profile by taking into account the fact that loads which are already off cannot be turned off to save power. Similarly, scheduled loads, when known to statistics server 210 (by being stored in configuration database 202), can be leveraged by taking into account the fact that a given load is scheduled to turn on in a period of interest, and overriding the schedule to keep it off, thus achieving a predictable load reduction for the period of interest.

In another embodiment of the invention, users can be assigned an “energy risk rating” analogous to a credit rating. Statistics server 210 calculates energy risk ratings by taking into account past user history, particularly concerning the degree to which a user honors his commitments. For example, if a user volunteers (by establishing preferences that are stored in configuration database 202) to allow 3 kilowatts of load to be controlled by digital exchange 100 during periods of demand response (or by volunteering to provide generated power of 3 kilowatts from a home wind turbine), and then fails to actually deliver according to what was volunteered (either because devices were off and therefore not available for load shedding, or wind was not available, or any other reason), then statistics server 210 decrements the energy risk rating for said user. As with credit scores, time can be a key parameter in adjusting energy risk ratings; after a series of failed commitments, it takes some time before the energy risk rating will rise back up following a change to actually honoring commitments.

It should be appreciated that the examples of statistical data generation provided heretofore are exemplary in nature and do not limit the scope of the invention. Essentially any statistics that can be calculated based on data available about users, their loads and available energy resources, their behaviors (for instance, one might be able to infer that a user is at home based on dynamic behavior of power usage, and use this to predict how responses might differ from those of a user away from home; in fact, preferences can be stated according to away or at home profiles, which can be inferred or directly declared as is done with home security systems when a user clicks “Away” to tell the system he is leaving the house), the consistency of their responses, their demographics, and so forth.

According to a preferred embodiment of the invention, rules engine 230 or an equivalent software module capable (equivalent in the sense that it meets the functional description provided herein, which is often done using a standards-based rules engine, but need not be so limited) receives events or notifications from one or more of the other components of the invention and executes any rules linked to said events or notifications. Events could be received from a third party via communications interface 220 (as when a user elects to invoke a response package that he has purchased through digital exchange 100), or from statistics server 210 (as when a statistic exceeds some configured threshold), or from one of the databases (as when a data element is added or changed). Events can also occur, and fire rules, based on calendars; for instance, a daily event might fire which causes a new set of response packages, for times during the day that is one week or one month in the future, to be created and stored in configuration database 202 (and made available for purchase on digital exchange 100 via communications interface 220). When an event is received, an event handler in rules engine 230 evaluates whether any rules are configured to be fired when an event of the type received occurs. If so, rules are executed in an order stipulated, as is commonly done with rules engines. Rules can generally invoke other rules, so an event's firing may cause a cascade of rules to “fire” or execute; rule invocation and execution continues until no further rules are remaining to be fired. Rules are stored alternatively either in the rules engine 230 itself, or in configuration database 202. In an embodiment of the invention, rules are established for the management of response packages, so that when a user changes or adds configuration data relating to loads or energy resources that can be controlled by digital exchange 100, a rule is fired which causes the user's response profile to be recalculated and the revised response profile to be stored in configuration database 202. Typically, whenever a response profile is added or changed, a rule will fire which either recalculates the expected statistical behavior of any response packages of which the changed user's response profile is an element, or determines if the newly added or changed response profile should be added to an existing or a new response package. Inclusion of a response profile in a response package may be based on a number of factors, including but not limited to the geographic location of the facility (home or small business) associated with the new user (for instance, if all users within a given substation's service area are to be included in a single response package), the demographics of the user (for instance, if a response package comprised of “affluent greens” is maintained, and a new user matching that profile is added), or the type of generation equipment available at the new user's facility (for instance, if all wind power generators are bundled into a plurality of wind-based response packages). In this latter case, in an embodiment of the invention the wind profiles of the geographic locations of various users who together comprise a response package can be combined by statistics server 210 into a composite wind generation response package profile that can then be used to announce to prospective buyers the availability of specified amounts of wind power at specified times. In some cases, there may be an insufficient number of response profiles in a given region, or of a given type, to make a reasonably sized (and reasonably well-behaved, which typically is a consequence of having a statistically significant mix of response profiles in a single response package) response package; in these cases, when a new user or set of resources (associated with an existing user) is added that is in the same region or has the same type, a rule is triggered which checks to see if there are now enough users, or enough load (or generating capacity) to create a new response package. If the answer is yes, then a new response package is created, and a request is sent to statistics server 210 to calculate the expected responses of the new response package. When the results are returned from the statistics server 210, they are stored in configuration database 202 and any rules for making the response package available via communications interface 220 are invoked. In this fashion (and through the use of scheduled events as discussed above), an inventory of available response packages is made available to potential buyers on digital exchange 100.

Another example of rules which are triggered by events according to the invention is when a demand for service is placed at the digital exchange 100. In an embodiment of the invention, when a consumer's preference, stored in configuration database 202, states that a given load should only be operated when power of a certain type is available (for instance, “don't run my dishwasher except using wind power”), and the consumer desires to operate the given load, then a request is placed to the digital exchange 100 for a package of wind power of sufficient quantity to provide for the given load. The placement of such a request constitutes an event which is stored at event database 200 and passed to rules engine 230 to determine if any rules are fired by the event. In this case, a rule would be fired which determines if there is any wind power available in sufficient quantity to provide for the given load. If not, a message is sent via communication interface 220 to user interface 221 to so inform the user. If there is a single source of wind suitable for the given load, then the capacity of a response package associated with the source is decremented for the relevant time interval (it could be the current time interval or a future time interval, for example when the given load is to be operated according to a schedule at a future time) by an amount equal to the expected demand from the given load. If there is more than one suitable source available for the given load, then the rule that was invoked will either resolve the situation itself if it is so designed, or it will invoke a further rule to select from among a plurality of sources the one that is most appropriate. Selection of sources can be made according to any criteria, including but not limited to price, proximity to the requesting user, energy risk rating of the various response packages, or a fairness routine that spreads equally priced demand among a plurality of sources of supply.

It should be appreciated that the examples of rules provided in the above are exemplary only and should not be taken to limit the scope of the invention. Rules engine 230 is the module that responds to events and that in effect creates an efficient market for energy based on aggregated response packages, which are in turn based on the detailed statistical behaviors of a plurality of individual users, loads and energy resources.

All of the embodiments outlined in this disclosure are exemplary in nature and should not be construed as limitations of the invention except as claimed below.

What is claimed is:

1. A system for managing energy, comprising:
a digital exchange with a communications interface adapted to allow connections from remote users over a data network;
wherein the digital exchange receives preferences from a plurality of exchange participants and these preferences are used at least in part to create response profiles relevant to the participants; and
wherein at least some of the response profiles are aggregated into response packages with defined statistical properties; and
wherein at least some of the response packages are made available for use by participants in the digital exchange.

2. A method for managing energy, comprising the steps of:
(a) receiving preferences from participants in a digital exchange;
(b) using those preferences at least in part to create response profiles relevant to the participants;
(c) aggregating at least some of the response profiles into response packages with defined statistical properties; and
(d) making at least some of the response packages available for use by participants in a digital exchange.
